(19) United States
(12) Patent Application Publication
(10) Pub. No.: US 2024/0145799 A1
(43) Pub. Date: May 2, 2024

(54) Battery and battery control method

(71) Applicant: Webasto SE, Stockdorf (DE)

(72) Inventors: Michael Zeilbeck, Stockdorf (DE); Norbert Botzen-Mayer, Stockdorf (DE); Christian Ziegler, Stockdorf (DE); Samantha Zimnik, Stockdorf (DE)

(21) Appl. No.: 18/565,712

(22) PCT Filed: Jun. 1, 2022
(86) PCT No.: PCT/EP2022/064910

§ 371 Date: Nov. 30, 2023

(30) Foreign Application Priority Data
Jun. 1, 2021 (DE) 10 2021 114 090.0

(51) Int. Cl. H01M 10/48; H01M 10/42; H01M 50/204; H01M 50/249

(52) U.S. Cl. CPC H01M 10/482; H01M 10/4257; H01M 10/486; H01M 50/204; H01M 50/249; H01M 2010/4271; H01M 2220/20

(57) ABSTRACT

The present invention relates to a battery, in the form of a high-voltage battery (HV battery), comprising at least the following battery elements: a cell compartment with a plurality of cell modules and associated cell measurement boards, a main control unit with a main board, a main microprocessor and a plurality of microelectronic/electronic elements, a switch box comprising two contactors for a positive HV line and a negative HV line, where a pressure sensor is provided for measuring pressure in the battery interior, and this pressure sensor is arranged outside the main board at one of the following locations: in the switch box, on a central secondary board, and/or on at least one cell measurement board.

### CROSS-REFERENCE TO RELATED APPLICATIONS

This application is a 35 U.S.C. § 371 National Stage Entry of International Application No. PCT/EP2022/064910 filed Jun. 1, 2022, which claims the priority benefit of German Patent Application Serial Number DE 10 2021 114 090.0 filed Jun. 1, 2021, all of which are incorporated herein by reference in their entirety for all purposes.

### TECHNICAL FIELD

The present invention relates to a battery and more particularly to a battery control method.

### BACKGROUND

Batteries, in particular batteries which have a multiplicity of cell modules, are monitored with regard to electrical and physical states. This also includes monitoring thermal states, in particular detecting so-called thermal breakdown. To detect a thermal event (thermal runaway) in one or more cells of a battery or of a battery system, the pressure or the pressure curve is evaluated, the pressure increase as a result of a pressure relief valve being opened, as a result of which in the interior of a battery increases significantly in a short time. This pressure measurement is performed, for example, by a pressure sensor which can be arranged on the main board, for example, as part of the battery management system (BMS). Such a “thermal event” (thermal runaway) is a state in which the heating increases independently due to chemical processes without any further external influence, such as, for example, the current load, and wherein the chemical process is simultaneously accelerated.

Such an arrangement is shown by DE 10 2018 210 975 B4, for example, in which a thermal event is detected by a pressure sensor arranged on a main board of the battery control unit.

### SUMMARY

Accommodating the pressure sensor on the main board is disadvantageous because this main board has to be physically enlarged further for this purpose, thereby making it difficult to accommodate it in the battery and further complicating the verification of the data from the pressure sensor on the main board according to the ASIL standard.

It is the object of the present invention to propose improved pressure detection.

This object is achieved according to the invention by a battery according to the features of claim 1 and a method according to the features of claim 9. Advantageous configurations are specified in the respective, associated dependent claims.

The object is accordingly achieved by a battery which is in the form of a high-voltage battery (HV battery) and comprises the following battery elements:
a single-level or multi-level cell compartment with a plurality of cell modules and associated cell measurement boards,
a main control unit with a main board, a main processor and a plurality of microelectronic/electronic elements or parts,
a switch box in which at least two contactors are arranged, at least one for each of a HV⁺ line and a HV⁻ line for connecting to a main circuit. The essence of the invention here is that a pressure sensor is provided for measuring pressure in the battery interior in order to detect a thermal event, that is to say when a setpoint temperature has been exceeded, and wherein the pressure sensor is arranged outside the main board at one of the following locations:
inside or in the region of the switch box,
on a central secondary board, which likewise constitutes an element or part of the battery and/or
on at least one cell measurement board, which are usually arranged directly on the cell modules.

In this case, a cell measurement board means a board which is arranged directly on or in a cell module and comprises microelectronic parts and components which are primarily used to control and evaluate the respective cell module and are connected to the main control unit and actuated by the latter. The secondary board is a further central board which is separate from the main control unit and/or the main board and which is likewise connected to the main control unit.

Instead of the term “switch box” used here, “s-box”, “switch-box” or “BJB” (battery junction box) is often also used. In somewhat rarer cases, the designation “e-box” may also be used for the same part.

In this case, “connected” is not to be understood in a restrictive sense and means both one or more connections for the voltage supply and current supply and also for the data-carrying communication. The communication can in particular be in the form of one of the customary bus technologies or serial interfaces, such as isoSPI, by way of separate individual cables or modulated on one or more current-carrying individual cables.

It is advantageous here if a pressure sensor is in each case arranged on a plurality of cell measurement boards, in particular if a pressure sensor is provided on each cell measurement board.

The big advantage of this solution is that a thermal event is detected directly in the vicinity of a specific cell module or group of cell modules. In particular, in the case of the arrangement of a plurality of pressure sensors, the source of the event can be narrowed down on the basis of the order of the detecting pressure sensors.

In an improved embodiment, a temperature sensor is provided on at least one of the cell measurement boards, which temperature sensor is arranged adjacent to the at least one pressure sensor on the same cell measurement board and/or on a cell measurement board of an adjacent cell module.

As a result, it is also possible to detect thermal events quickly and reliably using a small number of pressure and temperature sensors, and to furthermore narrow down these events with regard to the origin, that is to say the defective cell module or a group of cell modules.

In a further embodiment, the at least one pressure sensor is arranged on a central secondary board, wherein the secondary board is attached within the switch box, wherein an improvement to this is that at least one and in particular all the microelectronic high-voltage elements (HV elements) are arranged in the switch box, these elements being arranged either on the secondary board or on their own high-voltage board. The big advantage of transferring the microelectronic HV elements to a central secondary board is that the state detection and evaluation take place in the vicinity of the high-voltage lines (HV⁺, HV⁻) and of the cell modules and furthermore the shielding and protection of the data from these HV elements is improved in relation to the other microelectronic elements and parts on the main board and it becomes much easier to comply with the ASIL standard.

Since communication using the ASIL standard is required for the central secondary board in the present case and said communication is used for the pressure signal, advantageously no additional communication interface is necessary.

In this case, HV elements means in particular analog-to-digital converters (ADCs) in the form of galvanically isolated capacitive couplers, inductive couplers or optocouplers for transmitting data from the high-voltage range to a low-voltage range, and voltage measuring elements/chips.

Advantageously, a p secondary processor is arranged on the secondary board and/or the high-voltage board, which p secondary processor is primarily used to process the data and process the micro-parts arranged on the respective board and is connected to the main control unit and in particular the main microprocessor thereof.

Ideally, the battery has an outer battery housing, which is generally closed in a dust-tight and/or vapor-tight manner, and the battery elements are by and large arranged inside this battery housing. In this case, as one embodiment, a battery housing is also to be understood to mean a multi-part housing if the individual housing parts are combined with one another via a connecting channel or connecting space but continue to form a common battery space on the outside. In the present instance, this could be the case if the switch box is flange-mounted or screwed on or to a battery housing and an opening or a channel, which is closed to the atmosphere, is formed between the switch box and the interior of the battery housing. Connecting lines are usually laid in this channel or this opening.

In order to shield the interior of the battery, to shield against electromagnetic interference and in order to protect against soiling, it is advantageous if the switch box has its own box housing, which is at least partly closed, in particular completely closed. For the case in which electronics are installed in the box, it is advantageous if this box has or is formed of a metal housing. Greatly advantageous in this case is the easy handling and the possibility of prefabrication. A switch box consisting of many components can thus be produced externally as one structural unit and be connected to the HV battery in just a few steps to form one unit.

The invention also comprises a method for operating a battery, in particular a HV battery, which comprises a battery management system (BMS) with a main control unit and a main board and has a plurality of cell modules.

The essence of the inventive method is that at least one pressure sensor is provided in order to detect exceeding a thermal threshold value, generally referred to as a thermal event, in the interior of the battery and/or in the region of a cell compartment or the cell modules, which pressure sensor is arranged outside the main board.

Advantageously, the battery, in particular in the form of a HV battery, is provided in the form of a battery according to one of the variant embodiments described above. On the whole, high voltage (HV) in the present case largely means a voltage range from 60 V to 2000 V DC, in particular from 60 V to 1500 V DC, which relates in particular to the power requirements of e-vehicles, such as, for example, electrically driven passenger cars, trucks and buses.

Further details and advantages of the invention will now be explained in more detail on the basis of an exemplary embodiment illustrated in the drawings.

### BRIEF DESCRIPTION OF THE DRAWINGS

In the drawings:

FIG. 1 shows a schematic plan view of a HV battery having a two-level cell compartment,

FIG. 2 shows a schematic, alternative embodiment of a HV battery having a single-level cell compartment and a secondary board in the switch box and

FIG. 3 shows a further embodiment of a HV battery, similar to FIG. 2, wherein the secondary board comprises the HV elements.

### DETAILED DESCRIPTION

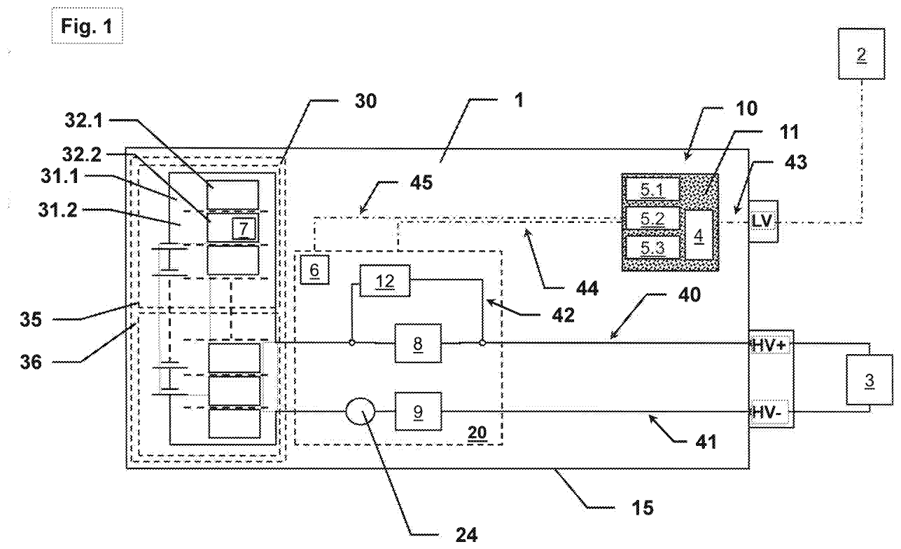

FIG. 1 shows a schematic design of a HV battery 1 which, as essential components, has a battery housing 15 inside which a main control unit 10, a switch box 20 and a cell compartment 30 having two levels 35, 36. The cell compartment 30 is divided into a plurality of cell modules 31.1 . . . 31.n, which has been indicated by way of a dashed, transverse line. Each cell module 31.1 . . . 31.n has an associated cell measurement board 32.1 . . . 32.n. The main control unit 10 and the main board 11 thereof are connected to a central control and supply unit 2 in a data-carrying and current-carrying manner via the LV line 43. The battery 1 is connected to one or more loads 3 via the HV lines 40, 41, as is indicated very schematically.

The HV⁺ line 40 is routed into the switch box 20 and to the contactor 8 there, which is used to switch the line 40. Similarly, the HV⁻ line 41 is likewise routed into the switch box 20 and to the contactor 9. Furthermore, there is provision for an auxiliary current path 42 on the HV⁺ line in the switch box 20 in order to operate the contactor 12, which acts as a precharging contactor. Furthermore, there is provision for a current sensor 24 in the switch box 20; other fuses, resistors or further components are not illustrated. The main board 11 is connected to the switch box 20 or individual components and parts in the switch box 20 via the line connection 44, this not having been distinguished in detail in the present case. The main board 11 comprises a plurality of microelectronic/electronic elements 5.1, 5.2, 5.3 and a main microprocessor 4. In the exemplary embodiment shown, the pressure sensor 6 according to the invention is arranged in the switch box 20 and connected to the main control unit 10, or the main board 11 thereof, via a separate line connection 45.

A temperature sensor 7 is mounted on the cell measurement board 32.2 and therefore in the immediate vicinity of the pressure sensor 6. In this case, the temperature sensor 7 is applied directly to the cell measurement board 32.2 as a surface-mounted device (SMD component). When the pressure sensor 6 detects a rapid increase in pressure, it is possible to ascertain whether the thermal event is originating from the level 35 or, because the temperature sensor 7 is not reporting increased values or is reporting them very late, the thermal event has to be originating from the level 36 of the cell compartment 30.

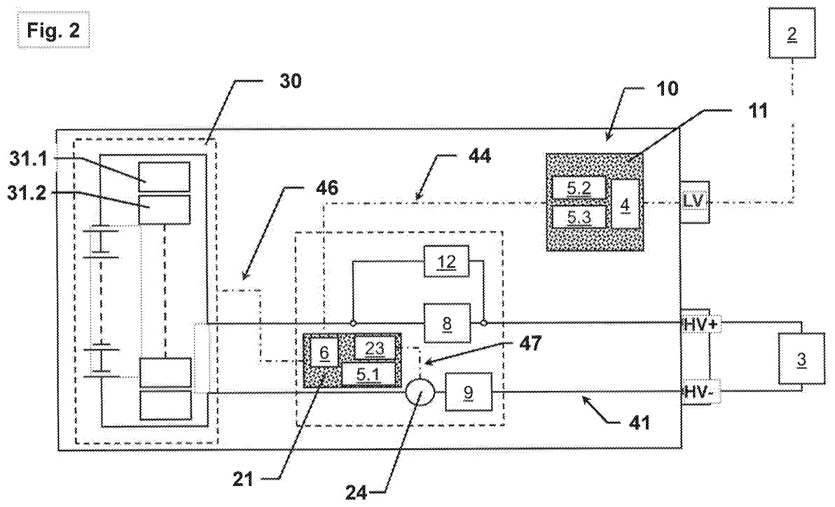

In the embodiment according to FIG. 2, the battery 1 has only one level of a cell compartment 30. The key aspect is that a secondary board 21 is arranged in the switch box 20, the pressure sensor 6 being placed on said secondary board as an SMD component. This secondary board 21 further comprises a secondary microprocessor 23 and the microelectronic HV elements 5.1 required for detecting and processing the HV states. These HV elements are in particular galvanically isolated analog-to-digital converters (ADCs) and voltage measuring elements.

The current sensor 24 on the HV⁻ line is connected via its own line 47 to the secondary board 21 and/or the p secondary processor 23. This secondary board 21 itself, as a subordinate element in the BMS, is connected on the one hand to the main board 11 via the line 44 and to the components of the cell compartment via the line 46. All the components which monitor and process the HV functions are thus combined in a separate space, namely the switch box 20, and can be shielded and protected in an appropriate manner.

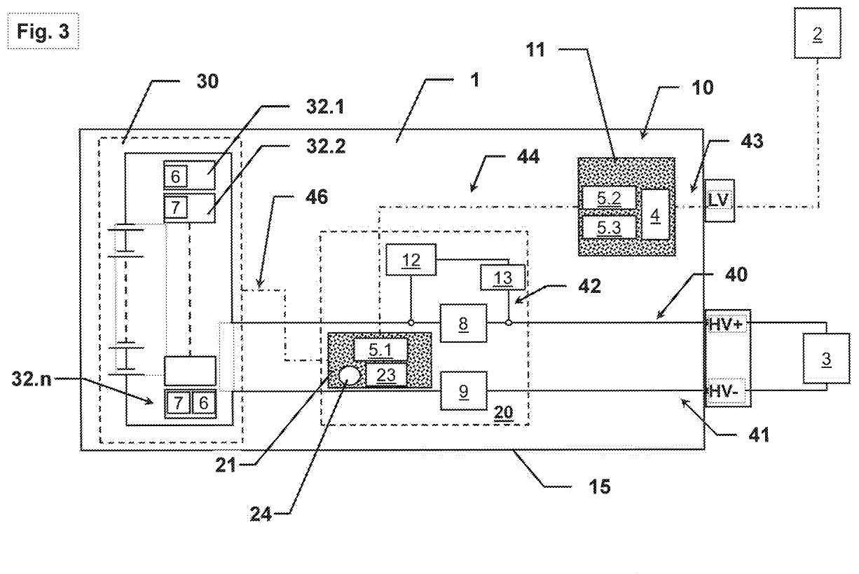

In the exemplary embodiment according to FIG. 3, which is very similar to that of FIG. 2, there is likewise provision for a secondary board 21 having the same components in the switch box 20. Furthermore, the current sensor 24 is now also arranged on this secondary board 21 as an SMD component. The difference for example with respect to FIG. 2 lies in the arrangement of the pressure and temperature sensors 6, 7. Two different arrangement options are shown in order to avoid too many sensors having to be provided. One embodiment consists in a pressure sensor 6 and a temperature sensor 7 being arranged adjacent to one another on the cell measurement boards 32.1, 32.2. Alternatively, the pressure sensor 6 and the temperature sensor 7 are arranged as an SMD component in the cell module 31.n on the associated cell measurement board 32.n.

FIG. 3 furthermore shows a customarily provided precharging resistor 13 inside the switch box 20. This precharging resistor can be arranged upstream or downstream of the contactor 12 which acts as a precharging contactor.

Both alternatives allow a logical evaluation of whether a thermal event is originating from the cell module itself, an immediately adjacent cell module or a remotely arranged cell module.

### LIST OF REFERENCE SIGNS

1 battery
2 control and supply unit
3 load
4 main microprocessor
5 element, (micro)electronic
   5.1 high-voltage element, microel.
   5.2 element, electr.
   5.3 element, electr.
6 pressure sensor
7 temperature sensor
8 contactor
9 contactor
10 main control unit
11 main board
12 contactor
13 precharging resistor
15 battery housing
20 switch box
21 secondary board
23 μ secondary processor
24 current sensor
25 cell compartment
31 cell module (31.1 . . . 31.n)
32 cell measurement board (32.1 . . . 32.n)
35 level, lower
36 level, upper
40 HV⁺ line
41 HV⁻ line
42 auxiliary current path
43 LV line
44 line connection
45 line connection
46 line
47 line

1. A battery, in the form of a high-voltage battery (HV battery), comprising at least the following battery elements:
a cell compartment with a plurality of cell modules and associated cell measurement boards,
a main control unit with a main board, a main processor and a plurality of electronic elements,
a switch box comprising two contactors for a HV⁺ line and a HV⁻ line, wherein a pressure sensor is provided for measuring pressure in the battery interior, and wherein the pressure sensor is arranged outside the main board at at least one of the following locations:
in the switch box,
on a central secondary board, and
on at least one cell measurement board.

2. The battery according to claim 1, wherein the pressure sensor is arranged on a plurality of cell measurement boards.

3. The battery according to claim 1, wherein
a temperature sensor is provided on at least one of the cell measurement boards, wherein
the temperature sensor is arranged at least one of: on the same cell measurement board and/or
on a cell measurement board of an adjacent cell module.

4. The battery according to claim 1, wherein at least one pressure sensor is arranged on a central secondary board, wherein the secondary board is attached in the switch box.

5. The battery according to claim 4, wherein at least one, high-voltage elements are arranged in the switch box, in that these are arranged at least one of: on the secondary board and or on a separate high-voltage board.

6. The battery according to claim 4, wherein at least one of: the secondary board and the high-voltage board has a μ secondary processor.

7. The battery according to claim 1, wherein the battery has an outer battery housing and the battery elements are arranged inside the outer battery housing.

8. The battery according to claim 1, wherein the switch box has its own box housing, which is at least partly closed, in particular completely closed.

9. A method for operating a battery which has a battery management system (BMS) with a main control unit comprising a main board and which comprises a plurality of cell modules, wherein
detecting exceeding of a thermal threshold value in at least one of: the interior of the battery and the region of the cell modules, by at least one pressure sensor, where the at least one pressure sensor is arranged outside the main board.

10. A method for operating a battery, comprising:
measuring pressure in a battery interior by a pressure sensor, wherein the pressure sensor is arranged outside a main board at at least one of the following locations: in a switch box, on a central secondary board, and on at least one cell measurement board;
wherein a cell compartment comprises a plurality of cell modules and associated cell measurement boards;
wherein a main control unit comprises the main board, a main processor and a plurality of electronic elements; and
wherein the switch box comprises two contactors for a HV⁺ line and a HV⁻ line.

11. The battery according to claim 5, wherein all high-voltage elements are arranged in the switch box.

12. The battery according to claim 5, wherein the high-voltage elements are at least one of: galvanically isolated analog-to-digital converters (ADCs) and voltage measuring elements.

13. The battery according to claim 1, wherein the switch box has its own box housing, which is completely closed.
